(19) United States
(12) Patent Application Publication
(10) Pub. No.: US 2013/0279023 A1
(43) Pub. Date: Oct. 24, 2013

(54) MINIATURE LENS

(71) Applicants: SINTAI OPTICAL (SHENZHEN) CO., LTD., Shenzhen (CN); ASIA OPTICAL INTERNATIONAL LTD., Tortola (GB)

(72) Inventor: Yuan-Chen Chen, Taichung (TW)

(73) Assignees: Asia Optical International Ltd., Tortola (GB); SINTAI OPTICAL (SHENZHEN) CO., LTD., Shenzhen (CN)

(21) Appl. No.: 13/706,802

(22) Filed: Dec. 6, 2012

(30) Foreign Application Priority Data
Apr. 18, 2012 (TW) 101113860

(51) Int. Cl. G02B 13/18

(52) U.S. Cl. CPC G02B 13/18
USPC 359/714

(57) ABSTRACT

A miniature lens includes an aperture, a first lens, a second lens, a third lens, a fourth lens, and a fifth lens in order along an optical axis from an object side to an image side. The first lens is a meniscus lens having a positive refractive power, and a convex side thereof faces the object side. The second lens is a biconvex lens having a positive refractive power. The third lens is a meniscus lens having a negative refractive power, and a convex side thereof faces the object side. The fourth lens has a positive refractive power. The fifth lens has a negative refractive power. All the lenses respectively have at least an aspheric side.

### BACKGROUND OF THE INVENTION

1. Field of the Invention

The present invention relates generally to an optical lens, and more particularly to a miniature lens.

2. Description of the Related Art

With advancement in technology, image capture devices, such as charge coupled device (CCD) or complementary metal oxide semiconductor (CMOS) are widely used in image pick-up apparatus, such as digital camera and cell phone. In recent days, the image pick-up apparatus is made as smaller as possible, so that the image capture devices have to reduce its size accordingly. The pixel of the image capture device is increasing, and therefore the lens must have high optical performance to reach the high resolution and contrast. Consequently, small size and high optical performance are the important facts of modern lenses.

In early days, it only needs one or two lenses in the lens of the image capture device, and now, in order to raise the optical performance, it needs a lot of lenses.

In present days, it usually has five or more lenses in a miniature lens for a sufficient optical performance. However, the lens of five lenses has a small size and a poor optical performance. The lens of more than five lenses has a good optical performance but the size is big.

In conclusion, the conventional miniature lens still has some places to be improved.

### SUMMARY OF THE INVENTION

The primary objective of the present invention is to provide a miniature lens, which only has five lenses to achieve both functions of small size and high optical performance.

According to the objective of the present invention, a miniature lens includes an aperture, a first lens, a second lens, a third lens, a fourth lens, and a fifth lens in order along an optical axis from an object side to an image side. The first lens is a meniscus lens having a positive refractive power, and a convex side thereof faces the object side. At least a side of the first lens is an aspheric side. The second lens is a biconvex lens having a positive refractive power. At least a side of the second lens is an aspheric side. The third lens is a meniscus lens having a negative refractive power, and a convex side thereof faces the object side. At least a side of the third lens is an aspheric side. The fourth lens has a positive refractive power, and at least a side thereof is an aspheric side. The fifth lens has a negative refractive power, and at least a side thereof is an aspheric side.

In an embodiment, both sides of the first lens are aspheric sides.

In an embodiment, both sides of the second lens are aspheric sides.

In an embodiment, both sides of the third lens are aspheric sides.

In an embodiment, both sides of the fourth lens are aspheric sides.

In an embodiment, the fourth lens is a meniscus lens, and a convex side thereof faces the image side.

In an embodiment, both sides of the fifth lens are aspheric sides.

In an embodiment, a refractive power of the fifth lens is gradually converted from negative into positive from a position where the optical axis passes through to an edge thereof.

In an embodiment, the fifth lens has an optical axis region at a side facing the object side, the optical axis passes through the optical axis region, a radius of curvature of the optical axis region of the side is positive, and a radius of curvature of the rest region of the side is negative.

In an embodiment, the fifth lens has an optical axis region at a side facing the image side, the optical axis passes through the optical axis region, a radius of curvature of the optical axis region of the side is positive, and a radius of curvature of the rest region of the side is negative.

In an embodiment, the first lens, the second lens, the third lens, the fourth lens, and the fifth lens are made of plastic.

Therefore, the miniature lens of the present invention has a small size and a high optical performance.

### BRIEF DESCRIPTION OF THE DRAWINGS

FIG. 1 is an arrangement diagram of a first preferred embodiment of the present invention, showing the path of light;

FIG. 2A is a field curvature diagram of the first preferred embodiment of the present invention;

FIG. 2B is a distortion diagram of the first preferred embodiment of the present invention;

FIG. 2C is a ray fan diagram of the first preferred embodiment of the present invention;

FIG. 2D is a spot diagram of the first preferred embodiment of the present invention;

FIG. 3 is an arrangement diagram of a second preferred embodiment of the present invention, showing the path of light;

FIG. 4A is a field curvature diagram of the second preferred embodiment of the present invention;

FIG. 4B is a distortion diagram of the second preferred embodiment of the present invention;

FIG. 4C is a ray fan diagram of the second preferred embodiment of the present invention; and

FIG. 4D is a spot diagram of the second preferred embodiment of the present invention.

### DETAILED DESCRIPTION OF THE INVENTION

The detailed description and technical contents of the present invention will be explained with reference to the accompanying drawings. However, the drawings are illustrative only but not used to limit the present invention.

### First Preferred Embodiment

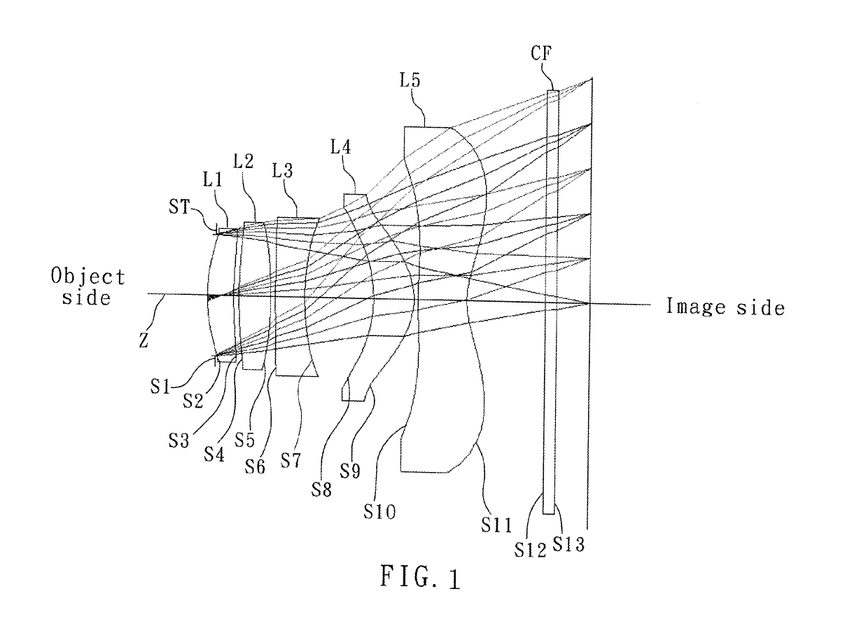

As shown in FIG. 1, a miniature lens 1 of the first preferred embodiment of the present invention includes an aperture ST, a first lens L1, a second lens L2, a third lens L3, a fourth lens L4, and a fifth lens L5 in order along an optical axis Z from an object side to an image side. In specified requirement, a color filter CF may be provided between the fifth lens L5 and the image side to filter the noise out and increase the optical performance.

The first lens L1 is a plastic meniscus lens having a positive refractive power. A convex side S2 of the first lens L1 faces the object side, and both sides S2, S3 thereof are aspheric sides.

The second lens L2 is a plastic biconvex lens having a positive refractive power. Both sides convex side S4, S5 of the second lens L2 are aspheric sides.

The third lens L3 is a plastic meniscus lens having a negative refractive power. A convex side S6 of the third lens L3 faces the object side, and both sides S6, S7 thereof are aspheric sides.

The fourth lens L4 is a plastic meniscus lens having a positive refractive power. A convex side S9 of the fourth lens L4 faces the image side, and both sides S8, S9 thereof are aspheric sides.

The fifth lens L5 is a plastic lens. It has a negative refractive power at a position where the optical axis Z passes through, and the refractive power is gradually converted from negative into positive from the position where the optical axis Z passes through to an edge of the fifth lens L5. The fifth lens L5 has an optical axis region at a side S10 which faces the object side, and the optical axis Z passes through the region. A radius of curvature of the optical axis region is positive, and a radius curvature of the rest portion of the side S10 is negative. The fifth lens L5 also has an optical axis region at a side S11 which faces the image side, and the optical axis Z passes through the region. A radius of curvature of the optical axis region is positive, and a radius curvature of the rest portion of the side S11 is negative.

With the specified arrangement of the lenses, including the specified series of refractive power from the first lens L1 to the fifth lens L5, positive, positive, negative, positive, and negative, and the aspheric sides of the lenses L1 to L5, the miniature lens 1 may have good imaging performance, short total track, and wide field of view angle (FOV).

The focus length (F), F-number (Fno), the radius of curvature at the optical axis of each lens (R), the distance in the optical axis Z between the sides of the neighboring lenses (D), the refractive index (Nd), and the Abbe number (Vd) of the miniature lens 1 of the first preferred embodiment are shown in Table 1.

TABLE 1
F = 4.082, Fno = 2.65

| | R (mm) | T (mm) | Nd | Vd | |
|---|---|---|---|---|---|
| S1 | ∞ | −0.1084507 | | | ST |
| S2 | 2.022887 | 0.3400355 | 1.534611 | 56.072148 | L1 |
| S3 | 5.319961 | 0.068 | | | |
| S4 | 5.830889 | 0.4006339 | 1.534611 | 56.072148 | L2 |
| S5 | −7.678462 | 0.063 | | | |
| S6 | 11.6468 | 0.3737575 | 1.632205 | 23.429915 | L3 |
| S7 | 3.128256 | 0.8792713 | | | |
| S8 | −1.60222 | 0.5127122 | 1.5441 | 56.093602 | L4 |
| S9 | −0.8665658 | 0.05027677 | | | |
| S10 | 4.257575 | 0.6236497 | 1.514648 | 56.963513 | L5 |
| S11 | 0.9896196 | 1 | | | |
| S12 | ∞ | 0.145 | 1.516798 | 64.198266 | CF |
| S13 | ∞ | 0.4316448 | | | |

The depression z of the aspheric surfaces S2, S3, S4, S5, S6, S7, S8, S9, S10, and S11 may be obtained by the following equation:

$$z = \frac{{ch}^{2}}{1 + {[ 1 - ( k + 1 ) {c}^{2} {h}^{2} ]}^{\frac{1}{2}}} + A {h}^{4} + {Bh}^{5} + {Ch}^{6} + {Dh}^{7} + {Eh}^{8} + {Fh}^{9} + {Gh}^{10} + {Hh}^{11} + {Ih}^{12} + {Jh}^{13} + {Kh}^{14} + {Lh}^{15} + {Mh}^{16} + {Nh}^{17} + {Oh}^{18} + {Ph}^{19} + {Qh}^{20}$$

where

z is the depression of the aspheric surface;

c is the reciprocal of radius of curvature;

h is the radius of aperture on the surface;

k is conic constant;

A˜Q are coefficients of the radius of aperture h.

The conic constants of the aspheric surfaces and the coefficients A˜Q are shown in Table 2.

TABLE 2

| | k | A | B | C | D | E |
|---|---|---|---|---|---|---|
| S2 | −12.59421 | 0.14102 | 0 | −0.14991 | 0 | −0.07541 |
| S3 | 14.3149 | −0.03905 | 0 | −0.18782 | 0 | 0.32813 |
| S4 | −94.71828 | 0.05138 | 0 | −0.16165 | 0 | 0.03605 |
| S5 | −768.9692 | −0.20265 | 0 | 0.16995 | 0 | 0.05096 |
| S6 | −517.956 | 0.02075 | −0.17624 | −0.09429 | 0.26864 | 0.21100 |
| S7 | 2.23161 | −0.01467 | 0 | −0.06957 | 0 | 0.20077 |
| S8 | −32.55569 | −0.78208 | 0.96620 | −0.09225 | −0.40433 | −0.08037 |
| S9 | −3.63499 | −0.29767 | 0.18348 | 0.00121 | 0.00377 | 0.06135 |
| S10 | 3.52404 | −0.39158 | 0.34388 | −0.03759 | −0.03812 | −0.01439 |
| S11 | −5.19232 | −0.35410 | 0.39189 | −0.02948 | −0.26685 | 0.21343 |
| | F | G | H | I | J | K |
| S2 | 0 | 0.35651 | 0 | −0.36566 | 0 | 0.05676 |
| S3 | 0 | −0.05976 | 0 | −0.23483 | 0 | −0.00276 |
| S4 | 0 | 0.73822 | 0 | −0.92680 | 0 | −0.10602 |
| S5 | 0 | −0.02798 | 0 | −0.15913 | 0 | −0.07122 |
| S6 | 0.07184 | −0.11564 | −0.23564 | −0.26213 | −0.07888 | 0.14942 |
| S7 | 0 | −0.11133 | 0 | −0.13282 | 0 | 0.21754 |
| S8 | 0.15328 | 0.04278 | 0.08190 | 0.04086 | −0.01558 | −0.02972 |
| S9 | −0.06673 | −0.02008 | 0.00918 | 0.01251 | 0.00632 | 0.00734 |
| S10 | 0.00447 | 0.00015 | 0.00496 | −0.00040 | −0.00033 | −0.00017 |
| S11 | −0.03325 | −0.03890 | 0.02334 | −0.00467 | 0.00014 | 7.98928e−5 |
| | L | M | N | O | P | Q |
| S2 | 0 | 0.05840 | 0 | 0 | 0 | 0 |
| S3 | 0 | 0.12067 | 0 | 0 | 0 | 0 |
| S4 | 0 | 0.40456 | 0 | 0 | 0 | 0 |
| S5 | 0 | 0.15329 | 0 | 0 | 0 | 0 |
| S6 | 0.28962 | 0.21858 | −0.04023 | −0.16487 | −0.21577 | 0.14478 |
| S7 | 0 | −0.08975 | 0 | 0 | 0 | 0 |
| S8 | −0.07157 | −0.04792 | 0.01354 | 0.06804 | 0.03319 | −0.04283 |
| S9 | 0.00515 | 0.00252 | −0.00479 | −0.00724 | −0.00357 | 0.00487 |
| S10 | −0.00010 | −0.00013 | 4.41471e−7 | 8.10431e−5 | −1.17991e−6 | −8.89279e−6 |
| S11 | 9.64668e−6 | −1.19637e−5 | −3.69459e−6 | 4.52913e−7 | 1.36876e−6 | −3.07834e−7 |

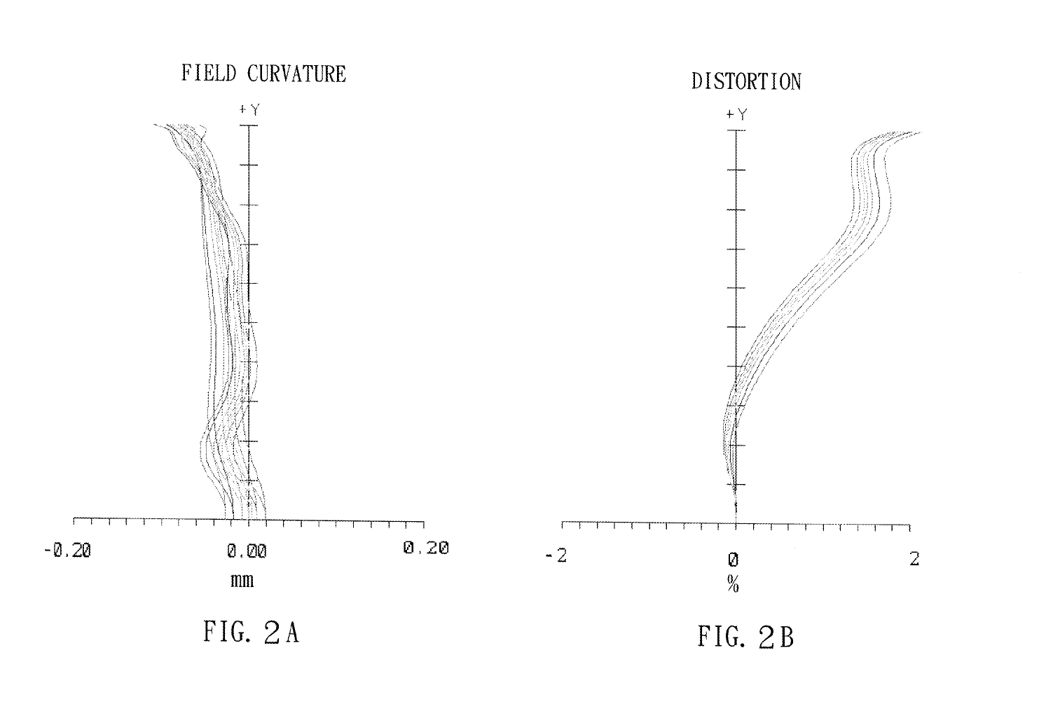

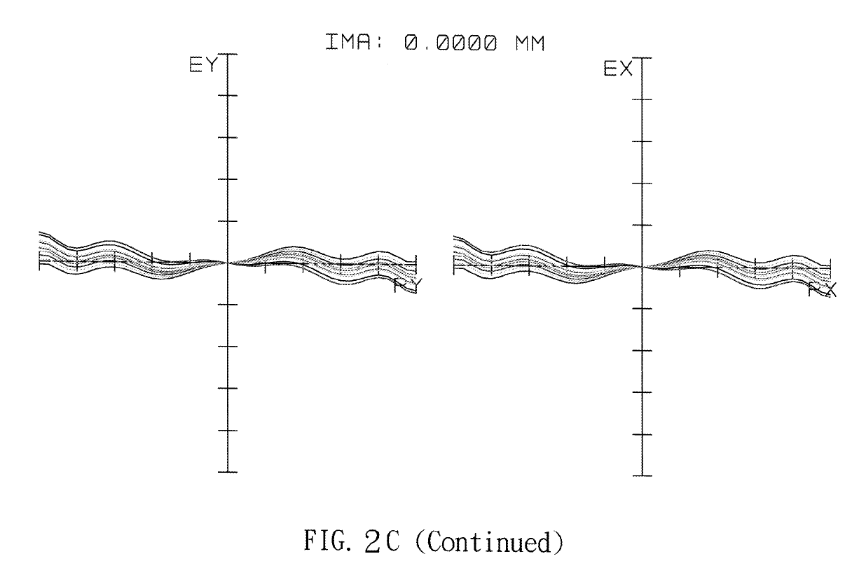

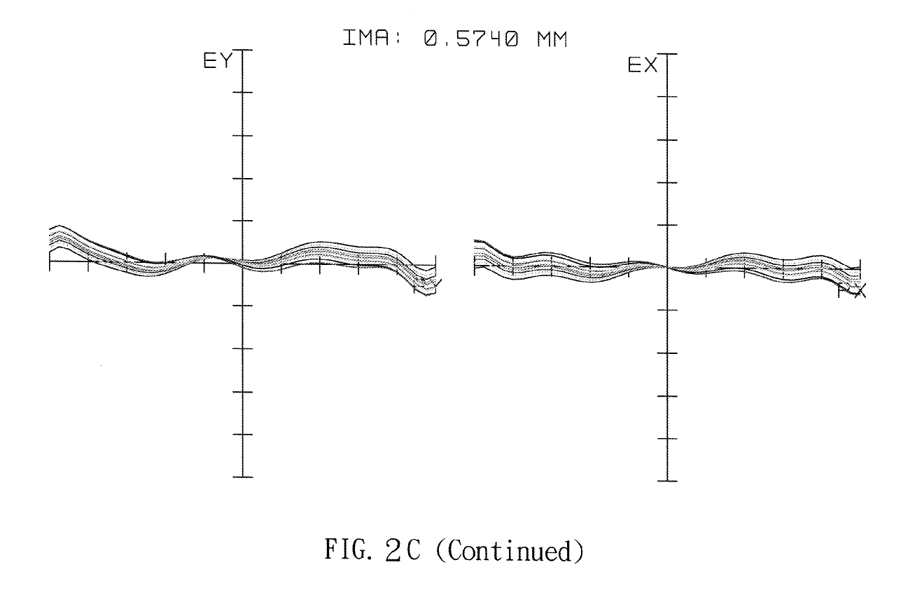

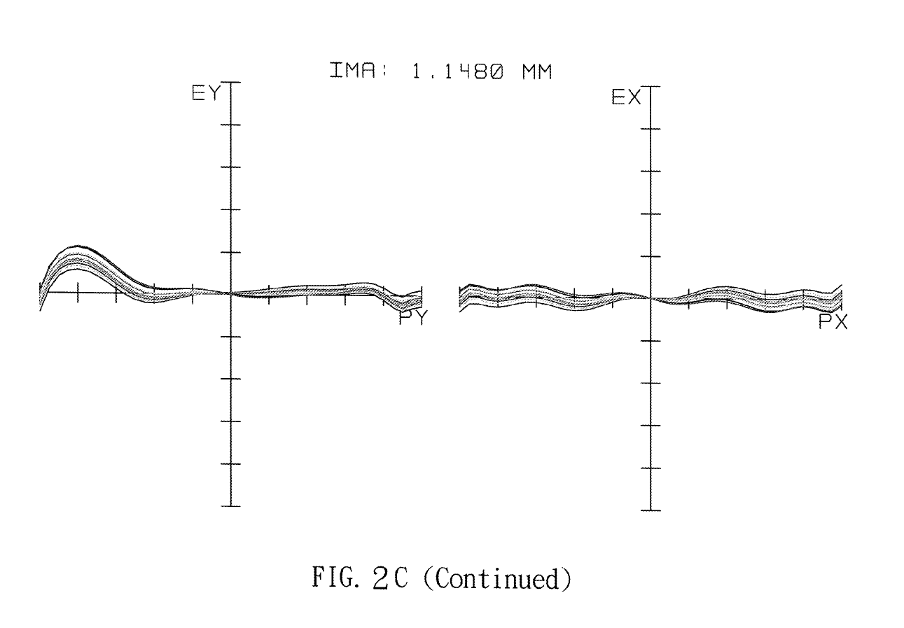

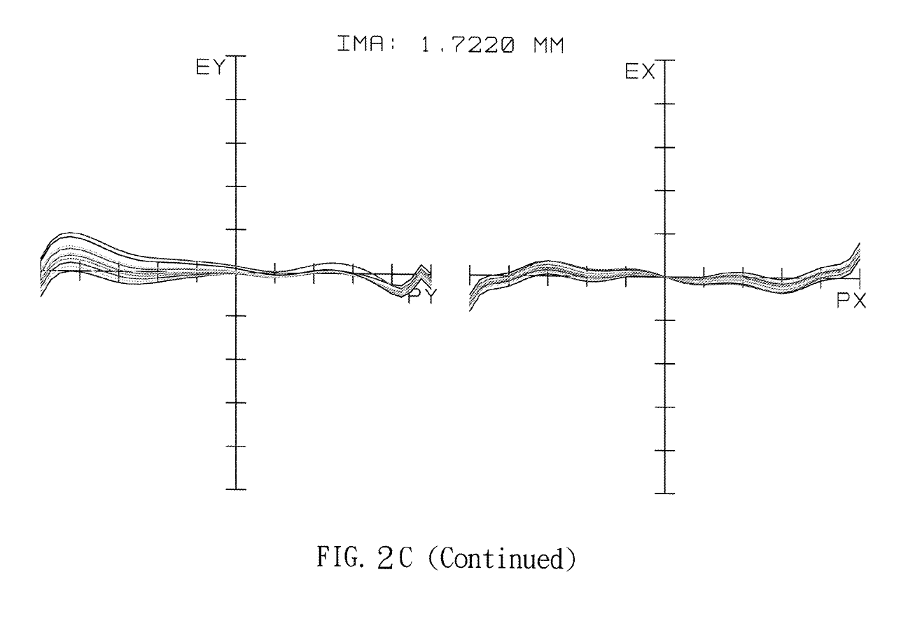

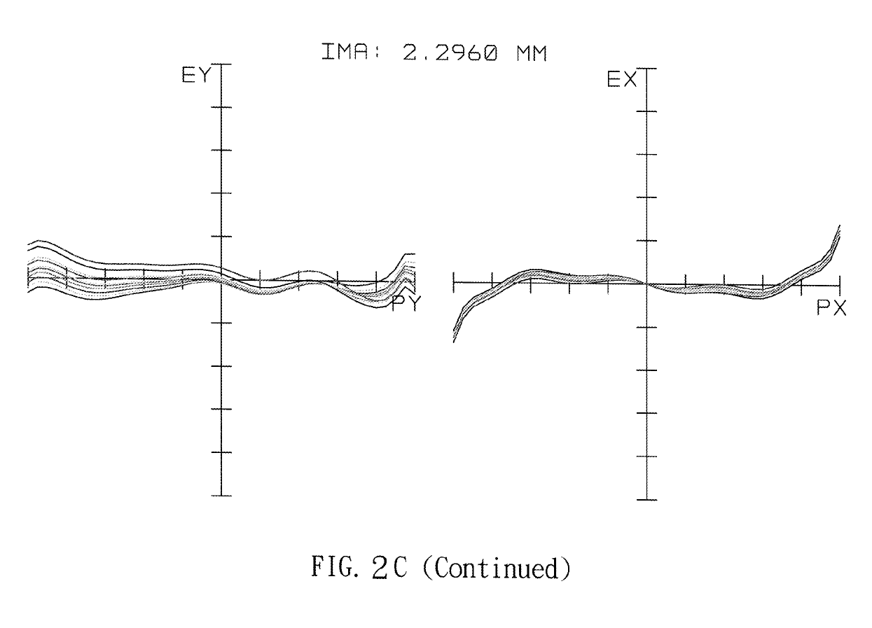

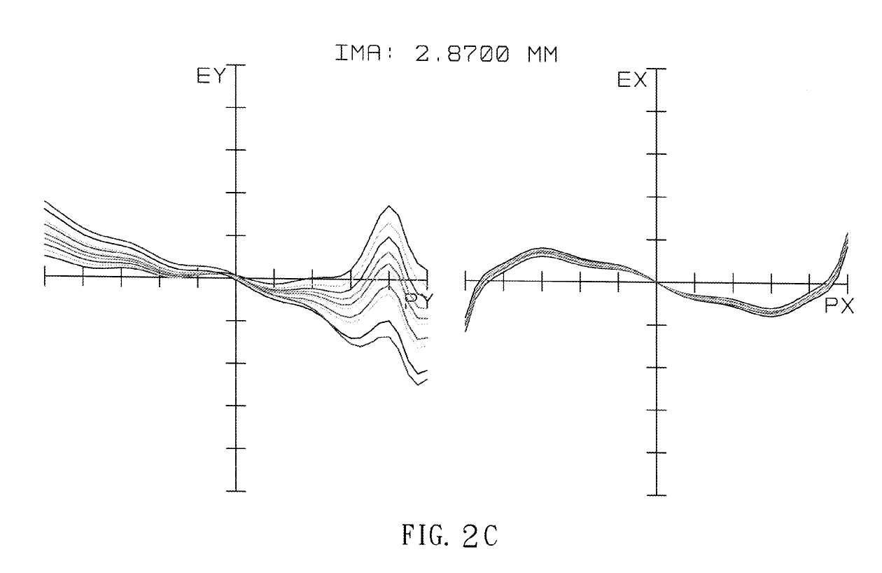

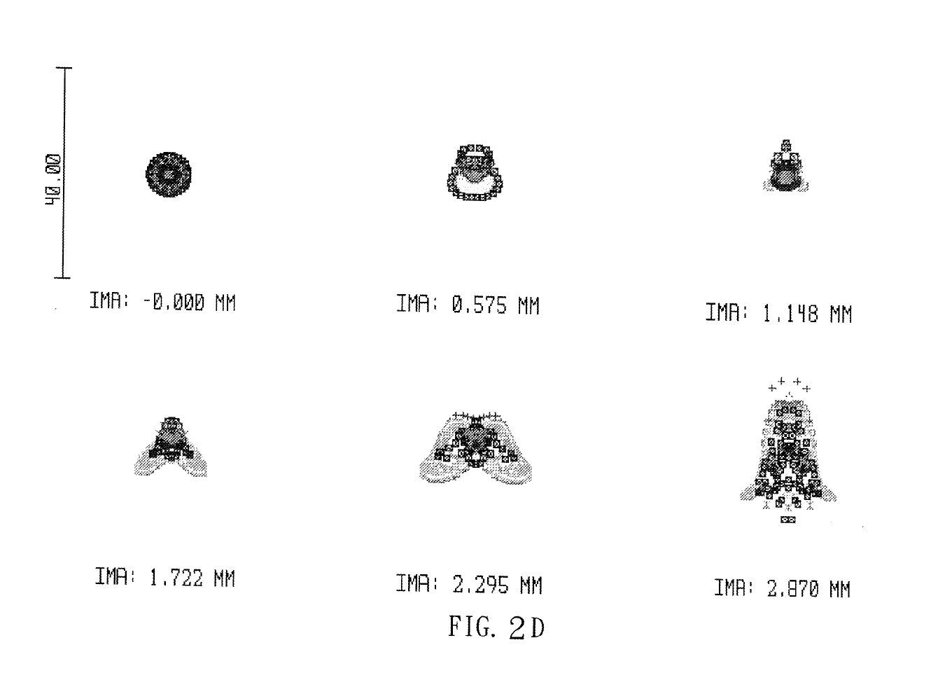

The lenses and the apertures ST as described above may reduce the size of the miniature lens 1 of the present invention. The miniature lens 1 still has a good optical performance in the wide-angle mode as shown in FIG. 2A to FIG. 2D.

In FIG. 2A, it shows that the maximum field curvature is about 0.02 mm and −0.12 mm. In FIG. 2B, it shows that the maximum distortion is about 2%. FIG. 2C shows that the miniature lens 1 has good resolution in any location of the field of view. FIG. 2D shows that RMS radius of the present invention is 1.081 μm and GEO radius is 3.653 μm at 0.000 mm of the field of view. RMS radius is 1.670 μm and GEO radius is 4.990 μm at 0.574 mm of the field of view. RMS radius is 1.364 μm and GEO radius is 6.508 μm at 1.148 mm of the field of view. RMS radius is 1.660 μm and GEO radius is 7.805 μm at 1.722 mm of the field of view. RMS radius is 2.405 μm and GEO radius is 10.649 μm at 2.296 mm of the field of view. RMS radius is 4.054 μm and GEO radius is 14.357 μm at 2.870 mm of the field of view. The test results show that the miniature lens 1 of the first preferred embodiment has qualified resolution and optical performance

### Second Preferred Embodiment

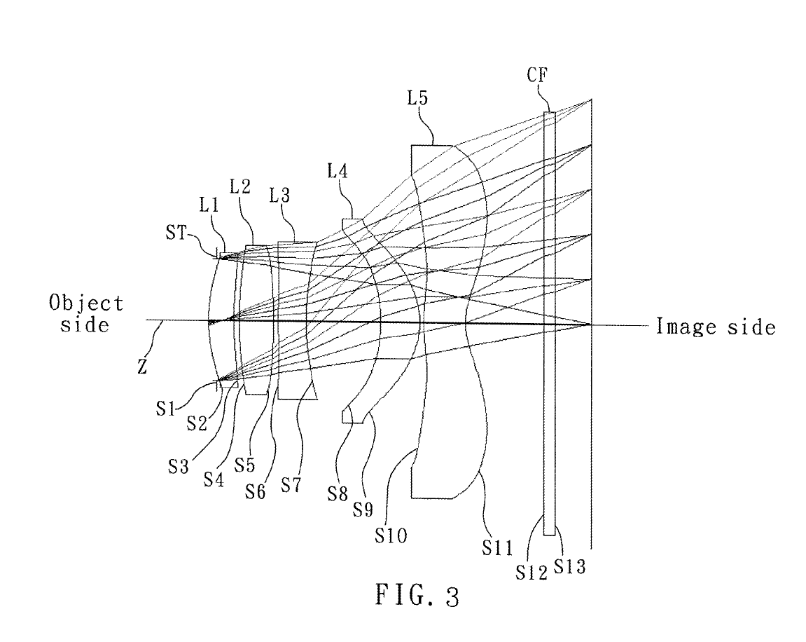

As shown in FIG. 3, a miniature lens 2 of the second preferred embodiment of the present invention includes an aperture ST, a first lens L1, a second lens L2, a third lens L3, a fourth lens L4, and a fifth lens L5 in order along an optical axis Z from an object side to an image side. In specified requirement, a color filter CF may be provided between the fifth lens L5 and the image side to filter the noise out and increase the optical performance.

The first lens L1 is a plastic meniscus lens having a positive refractive power. A convex side S2 of the first lens L1 faces the object side, and both sides S2, S3 thereof are aspheric sides.

The second lens L2 is a plastic biconvex lens having a positive refractive power. Both sides convex side S4, S5 of the second lens L2 are aspheric sides.

The third lens L3 is a plastic meniscus lens having a negative refractive power. A convex side S6 of the third lens L3 faces the object side, and both sides S6, S7 thereof are aspheric sides.

The fourth lens L4 is a plastic meniscus lens having a positive refractive power. A convex side S9 of the fourth lens L4 faces the image side, and both sides S8, S9 thereof are aspheric sides.

The fifth lens L5 is a plastic lens. It has a negative refractive power at a position where the optical axis Z passes through, and the refractive power is gradually converted from negative into positive from the position where the optical axis Z passes through to an edge of the fifth lens L5. The fifth lens L5 has an optical axis region at a side S10 which faces the object side, and the optical axis Z passes through the region. A radius of curvature of the optical axis region is positive, and a radius curvature of the rest portion of the side S10 is negative. The fifth lens L5 also has an optical axis region at a side S11 which faces the image side, and the optical axis Z passes through the region. A radius of curvature of the optical axis region is positive, and a radius curvature of the rest portion of the side S11 is negative.

With the specified arrangement of the lenses, including the specified series of the refractive powers from the first lens L1 to the fifth lens L5, positive, positive, negative, positive, and negative, and the aspheric sides of the lenses L1 to L5, the miniature lens 2 may have good imaging performance, short total track, and wide field of view angle (FOV).

The focus length (F), F-number (Fno), the radius of curvature at the optical axis of each lens (R), the distance in the optical axis Z between the sides of the neighboring lenses (D), the refractive index (Nd), and the Abbe number (Vd) of the miniature lens 2 of the second preferred embodiment are shown in Table 3.

TABLE 3
F = 4.082, Fno = 2.65

| | R (mm) | T (mm) | Nd | Vd | |
|---|---|---|---|---|---|
| S1 | ∞ | −0.1060938 | | | ST |
| S2 | 1.966577 | 0.3220708 | 1.534611 | 56.072148 | L1 |
| S3 | 4.520337 | 0.068 | | | |
| S4 | 5.567666 | 0.4324711 | 1.534611 | 56.072148 | L2 |
| S5 | −10.20405 | 0.063 | | | |
| S6 | 8.781035 | 0.3567071 | 1.632205 | 23.429915 | L3 |
| S7 | 3.10013 | 0.9583113 | | | |
| S8 | −1.716082 | 0.4989618 | 1.5441 | 56.093602 | L4 |
| S9 | −0.9547138 | 0.04805279 | | | |
| S10 | 1.980078 | 0.5316682 | 1.514648 | 56.963513 | L5 |
| S11 | 0.80794 | 1 | | | |
| S12 | ∞ | 0.145 | 1.516798 | 64.198266 | CF |
| S13 | ∞ | 0.465626 | | | |

The depression z of the aspheric surfaces S2, S3, S4, S5, S6, S7, S8, S9, S10, and S11 may be obtained by the following equation:

$$z = \frac{{ch}^{2}}{1 + {[ 1 - ( k + 1 ) {c}^{2} {h}^{2} ]}^{\frac{1}{2}}} + A {h}^{4} + {Bh}^{5} + {Ch}^{6} + {Dh}^{7} + {Eh}^{8} + {Fh}^{9} + {Gh}^{10} + {Hh}^{11} + {Ih}^{12} + {Jh}^{13} + {Kh}^{14} + {Lh}^{15} + {Mh}^{16} + {Nh}^{17} + {Oh}^{18} + {Ph}^{19} + {Qh}^{20}$$

where

z is the depression of the aspheric surface;

c is the reciprocal of radius of curvature;

h is the radius of aperture on the surface;

k is conic constant;

A˜Q are coefficients of the radius of aperture h.

The conic constants of the aspheric surfaces and the coefficients A˜Q are shown in Table 4.

TABLE 4

| | k | A | B | C | D | E |
|---|---|---|---|---|---|---|
| S2 | −6.922296 | 0.07089 | 0 | −0.08953 | 0 | 0.02412 |
| S3 | 9.457224 | −0.05026 | 0 | −0.19786 | 0 | 0.30279 |
| S4 | 32.07547 | 0.00423 | 0 | −0.20327 | 0 | 0.14712 |
| S5 | −2373.35 | −0.14435 | 0 | 0.03926 | 0 | 0.13171 |
| S6 | 70.660 | −0.03210 | −0.22318 | −0.09356 | 0.24226 | 0.24322 |
| S7 | −0.5573374 | −0.03358 | 0 | −0.10606 | 0 | 0.26808 |
| S8 | −43.17118 | −0.65330 | 0.78796 | −0.15549 | −0.36956 | −0.09274 |
| S9 | −3.736654 | −0.30184 | 0.15314 | −0.01806 | −0.00155 | 0.05654 |
| S10 | −12.37354 | −0.55862 | 0.48458 | −0.00884 | −0.05744 | −0.02317 |
| S11 | −4.387624 | −0.39835 | 0.41047 | −0.01398 | −0.27201 | 0.21030 |
| | F | G | H | I | J | K |
| S2 | 0 | 0.07998 | 0 | −0.37253 | 0 | 0.59500 |
| S3 | 0 | 0.01816 | 0 | −0.14772 | 0 | −0.15269 |
| S4 | 0 | 0.65707 | 0 | −0.92076 | 0 | −0.00058 |
| S5 | 0 | 0.06942 | 0 | −0.20293 | 0 | −0.23205 |
| S6 | 0.09368 | −0.11051 | −0.23204 | −0.27749 | −0.09424 | 0.14867 |
| S7 | 0 | −0.19091 | 0 | −0.10654 | 0 | 0.25077 |
| S8 | 0.17963 | 0.05936 | 0.09243 | 0.02682 | −0.01662 | −0.05435 |
| S9 | −0.06563 | −0.01709 | 0.01179 | 0.01276 | 0.00666 | 0.00735 |
| S10 | 0.00241 | 0.00068 | 0.00566 | 1.68186e−6 | −0.00016 | −0.00015 |
| S11 | −0.03335 | −0.03843 | 0.02356 | −0.00464 | 0.00011 | 6.20386e−5 |
| | L | M | N | O | P | Q |
| S2 | 0 | −0.34435 | 0 | 0 | 0 | 0 |
| S3 | 0 | 0.11430 | 0 | 0 | 0 | 0 |
| S4 | 0 | 0.23119 | 0 | 0 | 0 | 0 |
| S5 | 0 | 0.25102 | 0 | 0 | 0 | 0 |
| S6 | 0.27344 | 0.22097 | −0.02210 | −0.14478 | −0.20781 | 0.11929 |
| S7 | 0 | −0.10036 | 0 | 0 | 0 | 0 |
| S8 | −0.07116 | −0.04751 | 0.01864 | 0.07198 | 0.03603 | −0.04262 |
| S9 | 0.00557 | 0.00227 | −0.00445 | −0.00685 | −0.00348 | 0.00459 |
| S10 | −0.00012 | −0.00015 | −1.51790e−5 | 7.45616e−5 | −1.04900e−6 | −5.83177e−6 |
| S11 | 1.79572e−6 | −1.21632e−5 | −2.40172e−6 | 1.16670e−6 | 1.57319e−6 | −4.82034e−7 |

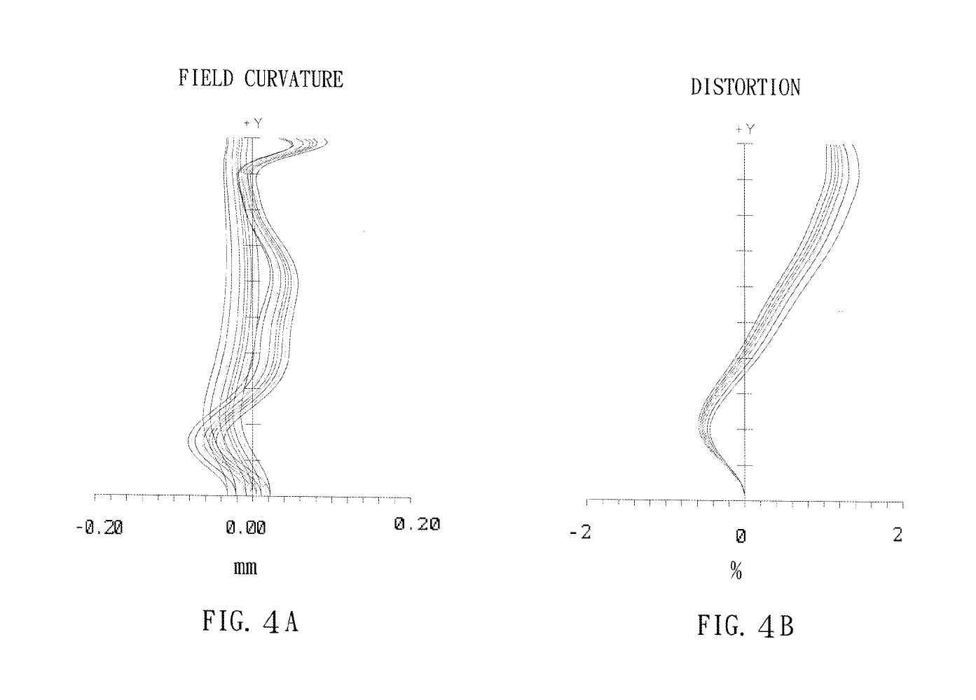

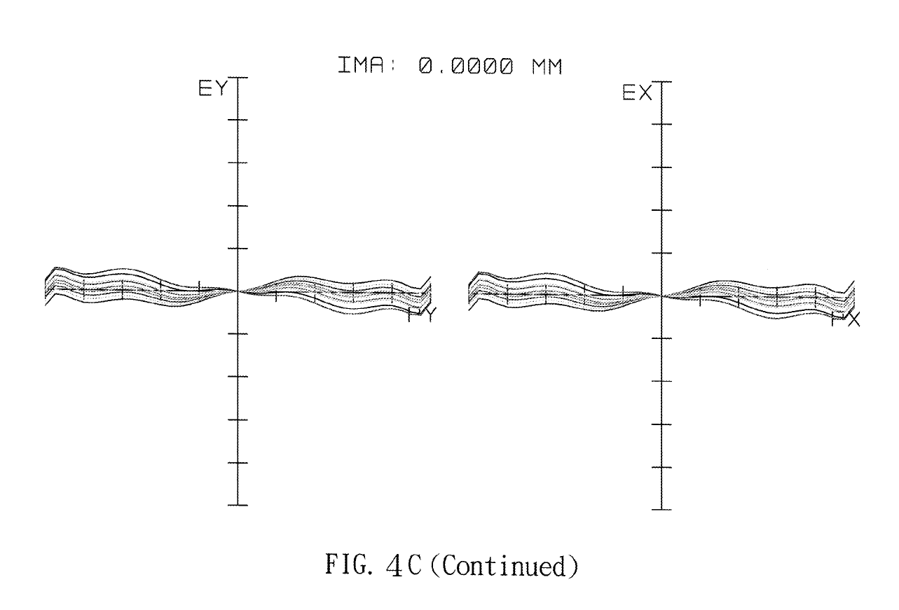

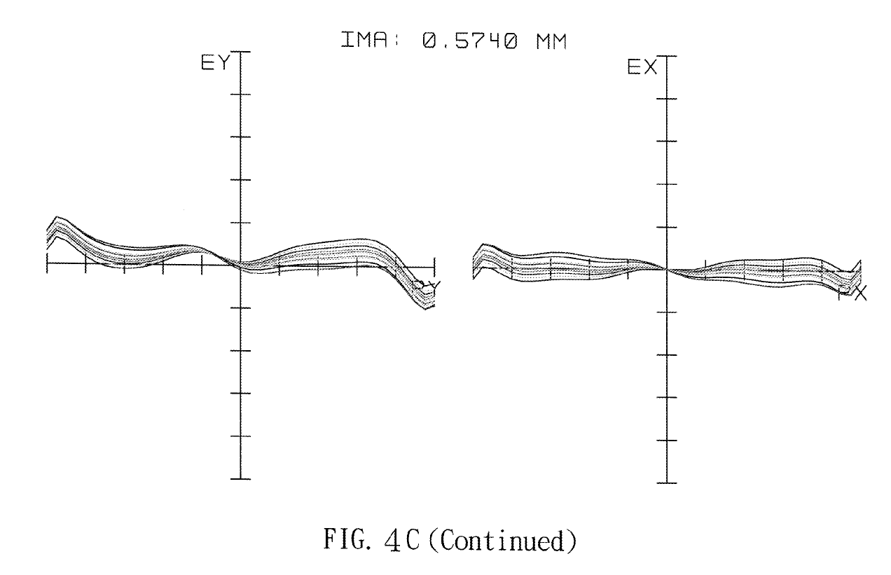

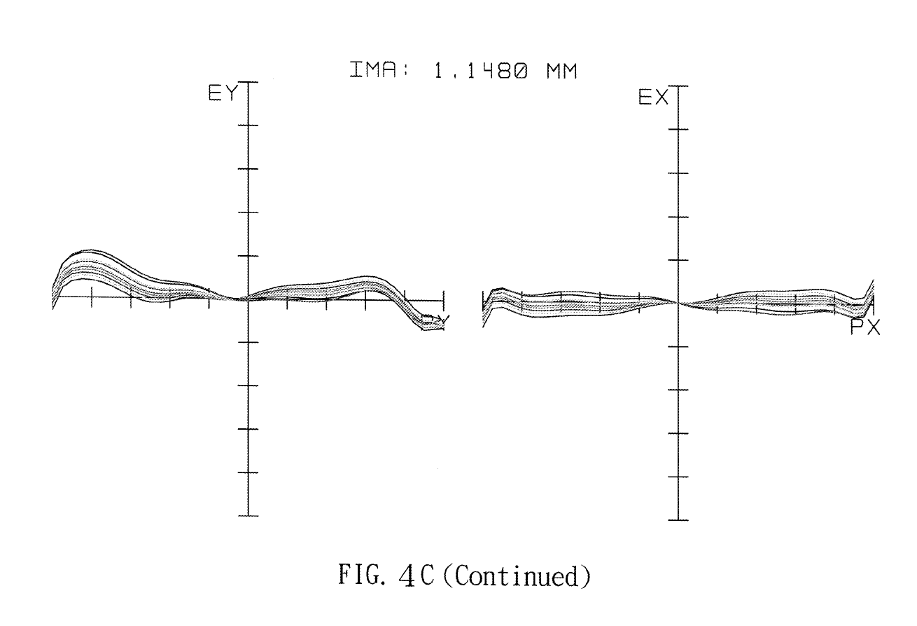

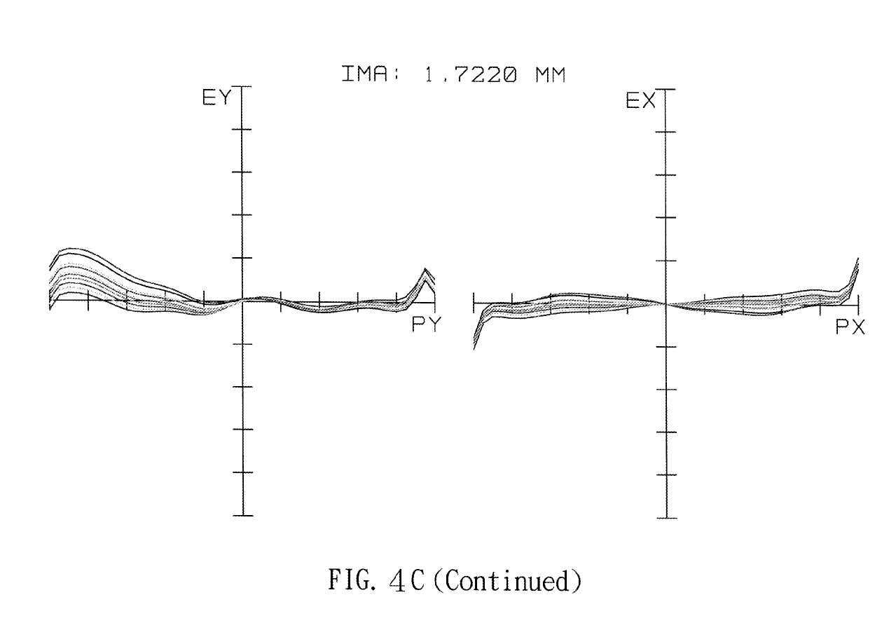

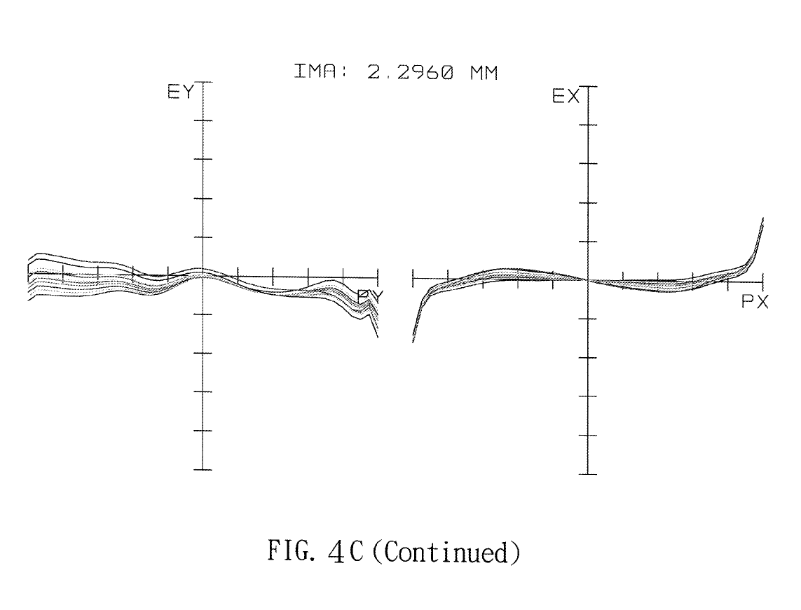

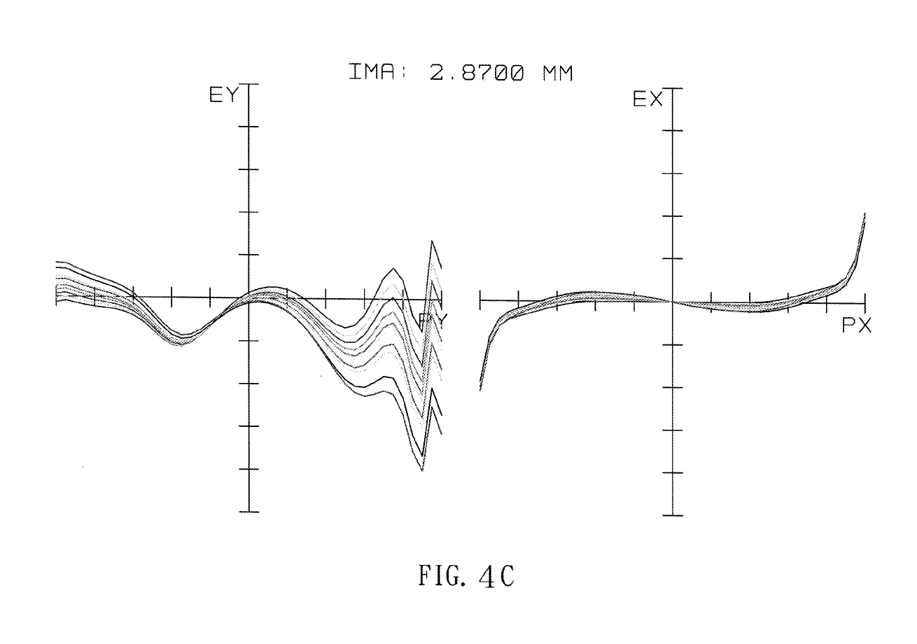

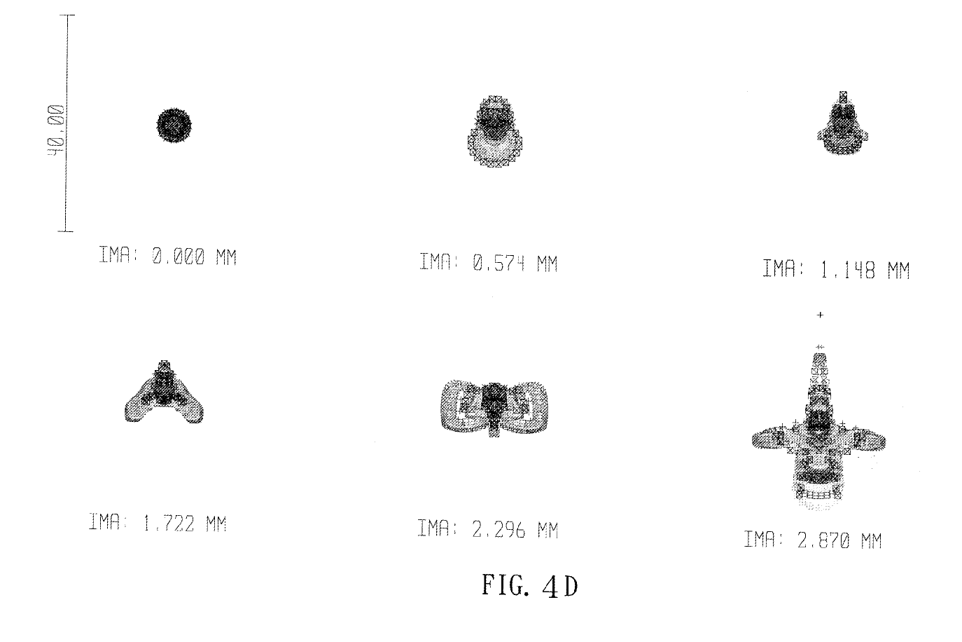

The lenses and the apertures ST as described above may reduce the size of the miniature lens 2 of the present invention. The miniature lens 2 still has a good optical performance in the wide-angle mode as shown in FIG. 4A to FIG. 4D.

In FIG. 4A, it shows that the maximum field curvature is about 0.10 mm and −0.08 mm. In FIG. 4B, it shows that the maximum distortion is about 1.6%. FIG. 4C shows that the miniature lens 1 has good resolution in any location of the field of view. FIG. 4D shows that RMS radius of the present invention is 0.837 μm and GEO radius is 2.728 μm at 0.000 mm of the field of view. RMS radius is 2.264 μm and GEO radius is 6.172 μm at 0.574 mm of the field of view. RMS radius is 1.749 μm and GEO radius is 6.127 μm at 1.148 mm of the field of view. RMS radius is 1.881 μm and GEO radius is 7.846 μm at 1.722 mm of the field of view. RMS radius is 2.781 μm and GEO radius is 10.082 μm at 2.296 mm of the field of view. RMS radius is 5.325 μm and GEO radius is 18.000 μm at 2.870 mm of the field of view. The test results show that the miniature lens 2 of the first preferred embodiment has qualified resolution and optical performance

In conclusion, the miniature lens of the present invention has a small size and a high optical performance.

The description above is a few preferred embodiments of the present invention and the equivalence of the present invention is still in the scope of claim construction of the present invention.

What is claimed is:

1. A miniature lens, in order along an optical axis from an object side to an image side, comprising:
an aperture;
a first lens, which is a meniscus lens having a positive refractive power, and a convex side thereof faces the object side, wherein at least a side of the first lens is an aspheric side;
a second lens, which is a biconvex lens having a positive refractive power, wherein at least a side of the second lens is an aspheric side;
a third lens, which is a meniscus lens having a negative refractive power, and a convex side thereof faces the object side, wherein at least a side of the third lens is an aspheric side;
a fourth lens having a positive refractive power, wherein at least a side of the fourth lens is an aspheric side; and
a fifth lens having a negative refractive power, wherein at least a side of the fifth lens is an aspheric side.

2. The miniature lens as defined in claim 1, wherein both sides of the first lens are aspheric sides.

3. The miniature lens as defined in claim 1, wherein both sides of the second lens are aspheric sides.

4. The miniature lens as defined in claim 1, wherein both sides of the third lens are aspheric sides.

5. The miniature lens as defined in claim 1, wherein both sides of the fourth lens are aspheric sides.

6. The miniature lens as defined in claim 1, wherein the fourth lens is a meniscus lens, and a convex side thereof faces the image side.

7. The miniature lens as defined in claim 1, wherein both sides of the fifth lens are aspheric sides.

8. The miniature lens as defined in claim 1, wherein a refractive power of the fifth lens is gradually converted from negative into positive from a position where the optical axis passes through to an edge thereof.

9. The miniature lens as defined in claim 1, wherein the fifth lens has an optical axis region at a side facing the object side, the optical axis passes through the optical axis region, a radius of curvature of the optical axis region of the side is positive, and a radius of curvature of the rest region of the side is negative.

10. The miniature lens as defined in claim 1, wherein the fifth lens has an optical axis region at a side facing the image side, the optical axis passes through the optical axis region, a radius of curvature of the optical axis region of the side is positive, and a radius of curvature of the rest region of the side is negative.

11. The miniature lens as defined in claim 1, wherein the first lens, the second lens, the third lens, the fourth lens, and the fifth lens are made of plastic.
